(19) United States
(12) Patent Application Publication
(10) Pub. No.: US 2024/0169172 A1
(43) Pub. Date: May 23, 2024

(54) METHOD FOR OPERATING A SYSTEM WITH A PLURALITY OF CODE READING UNITS AND MAIN DEVICES, SYSTEM AND CODE READING UNIT

(71) Applicant: Workaround GmbH, München (DE)

(72) Inventors: Bozidar JEVIC, München (DE); Damjan Novakovic, Priboj (RS); Dhanajay Gundapu Jayakrishnan, München (DE); Suzana Tasic, Belgrad (RS)

(21) Appl. No.: 18/517,119

(22) Filed: Nov. 22, 2023

(30) Foreign Application Priority Data
Nov. 23, 2022 (DE) 10 2022 131 039.6

(51) Int. Cl. G06K 7/14

(52) U.S. Cl. CPC G06K 7/1417

(57) ABSTRACT

A method for operating a system including generating a first code having encoded a first identifier, displaying the first code by a main device, reading the first code by a first code reading unit obtaining the first identifier, broadcasting the first identifier by the first code reading unit, and establishing a wireless connection between the main device and the first code reading unit based on the first identifier by: detecting by the main device the first code reading unit broadcasting the first identifier, sending a connection request, and receiving a connection response from the first code reading unit, wherein at least one of the connection response does not contain the first identifier; or the main device refrains from caching the first code reading unit with the first identifier. Further, a system and a code reading unit are provided.

### FIELD OF THE DISCLOSURE

The disclosure concerns a method for operating a system comprising a plurality of code reading units and main devices; as well as a system and a code reading unit.

### BACKGROUND

Systems comprising a plurality of code reading units and main devices are well known, in particular in shop floors like warehouses and manufacturing lines.

During operation of the system, wireless connections have to be established between a code reading unit and a particular main device in order to transfer data from the code reading unit to the main device and vice versa. However, in situations with many code reading units and many main devices within the range of each other, pairing of a code reading unit with the correct main devices is difficult.

In order to establish a wireless connection between two devices, it is known, for example from US 2021/0051016 A1, to have one of the devices optically scan a code displayed on the other device. Once the wireless connection has been established, measures are taken to keep the wireless connection, at least to the last connected device, open and to allow an easy reconnect.

However, if the main devices are moving independently of the code reading units, and the main devices need to change the wireless connections between various code reading units frequently, connections between the wrong pair of main device and code reading unit are difficult to avoid and a smooth operation of the system is hard to achieve.

### SUMMARY

There is provided a method for operating a system comprising a plurality of code reading units and main devices that allows a smooth and reliable change of wireless connections between a main device and varying code reading units.

There is further provided, a method for operating a system. The method comprises a plurality of code reading units with a code reader and a wireless communication module and a main device having a display and a wireless communication module. The method comprises the following steps:
generating a first code readable by the code reading units, the first code having encoded a first identifier therein,
displaying the first code on the display by the main device and searching for a code reading unit broadcasting the first identifier by the main device using the wireless communication module,
reading the first code and decoding the first code by a first code reading unit of the plurality of code reading units obtaining the first identifier,
broadcasting the first identifier by the first code reading unit using the wireless communication module, and
establishing a wireless connection between the main device and the first code reading unit based on the first identifier.

The wireless connection between the main device and the first code reading unit is established by the following steps:
detecting, by the main device using the wireless communication module, the first code reading unit broadcasting the first identifier,
sending, by the main device using the wireless communication module, a connection request to the first code reading unit, and
receiving, by the main device using the wireless communication module, a connection response to the connection request from the first code reading unit.

The connection response does not contain the first identifier and/or the main device refrains from caching the first code reading unit with the first identifier.

By not including the first identifier in the connection response or not storing the first identifier together with the first code reading unit, i.e. information about the first code reading unit like the advertising name, reconnection of the two devices, once the wireless connection has been terminated, is not possible. This simplifies the procedure of connecting the main device with another code reading unit drastically.

This type of handshake with the connection response not including the first identifier may be referred to as “single-handshake” compared to a “double-handshake” procedure in which the first identifier is part of the connection response yet again.

In particular, the code is a one-dimensional barcode or multidimensional optically machine readable code.

Any numerals, like “first” and “second”, are only used for differentiation and do not imply a specific amount or order of components.

In an aspect, the codes having encoded therein a setting for the wireless communication module of the code reading unit to not include the first identifier in the connection response, wherein the code reading unit adopts the setting after reading the respective code. This way, it is reliably prevented that the first identifier is included in the connection response.

In an embodiment, once the wireless connection between the first code reading unit and the main device has been established, the main device continues searching for a code reading unit other than the first code reading unit broadcasting the first identifier using the wireless communication module. This state, in which the main device searches for code reading units broadcasting a specific identifier, is also called state of continuous availability. The state of continuous availability allows for smoothly connecting a different code reading unit to the main device.

The state of continuous availability of the main device, for example, further eliminates the need for user input in order to generate and display the code for each code reading unit.

Alternatively or in addition, once the wireless connection between the first code reading unit and the main device has been established, the main device displays a code on the display, the code being the first code or a second code, the second code having encoded therein a second identifier, and/or the main device searches for a code reading unit other than the first code reading unit broadcasting the second identifier using the wireless communication module. Using the same code (first code) reduces complexity, whereas using a different code (second code) prevents accidental reconnections to the first device.

For further simplification, the code may be displayed automatically and/or even while the wireless connection between the main device and the first code reading unit is still active.

In particular, “automatically” means that no user input is required to generate and display first or second code.

Further, “still active” may include cases in which the wireless connection between the main device and the first code reading unit is terminated due to a request, in particular a user request, to display the second code.

In particular, switching the code reading units connected to the main device does not require any user initiated disconnection of the first code reading unit in order to initiate a connection of the main device with another (second) code reading unit.

For example, once the main device detects a second code reading unit of the plurality of code reading units broadcasting the first or the second identifier, the main device terminates the connection to the first code reading unit and establishes a connection with the second code reading unit, providing a quick and reliable change of the code reading unit connected to the main device.

In an embodiment, the wireless communication module of the code reading units and/or of the main device is set to refrain from attempts to reconnect to the main device or to a previous connected code reading unit, respectively, once the established wireless connection between the first code reading unit and the main device has been terminated. This way, previously connected code reading units do not obstruct the connection of other code reading units.

In order to ensure that the code reading units refrain from attempts to reconnect, the codes may have encoded therein a setting for the wireless communication module of the code reading unit to refrain from attempts to reconnect to the main device, wherein the code reading unit adopts the setting after reading the respective code.

For example, the first and second identifiers are advertising names and/or different from one another, to allow reliable identification of devices.

The wireless connection may be a Bluetooth connection, in particular a Bluetooth-Low-Energy connection, or a WLAN connection, providing reliable connectivity.

The wireless communication modules may then be Bluetooth-enabled modules, in particular Bluetooth-Low-Energy-enabled modules or WLAN modules.

In an aspect, the codes may have encoded therein a unique identifier of the main device to ensure connection to the main device that had issued the first code.

In an embodiment, the system comprises an automated vehicle, in particular an autonomous vehicle, the vehicle comprising the main device. The use of automated vehicles greatly improves the efficiency of the system.

For example, the main device may be a smart device, in particular a smartphone, a tablet or a laptop, making use of widely available components.

To improve efficiency further, the code reading unit may be worn on the body of a user.

For example, the system comprises an article of clothing, in particular a glove, which is designed to attach the code reading unit to the body of the user. This way, the code reading unit may be used flexibly as part of the hand.

In particular, the article of clothing has a holder for the code reading unit.

The article of clothing may have an actuating element which is connected to the code reading unit such that it can actuate the code reading unit.

Further a system is provided. The system comprises a plurality of code reading units with a code reader and a wireless communication module, and a main device having a display and a wireless communication module, wherein the code reading unit and the main device are configured to carry out a method as described above.

The features and advantages described with respect to the method also apply to the system and vice versa.

The components of the system that carry out a step of the method are, of course, configured to do so.

Further, there is provided, a code reading unit with a code reader and a wireless communication module, wherein the code reading unit is configured to:
read a first code displayed by a main device and decode the first code obtaining a first identifier,
broadcast the first identifier using the wireless communication module, and
establish a wireless connection with the main device based on the first identifier by sending a connection response in response to a connection request from the main device, wherein the connection response does not contain the first identifier.

The features and advantages described with respect to the method and the system also apply to the code reading unit and vice versa.

In particular, the code reading unit is configured to carry out the steps of the method as described above that are carried out by the code reading unit.

For example, the code reading unit is configured to refrain from attempts to reconnect to the main device.

### BRIEF DESCRIPTION OF THE DRAWINGS

Further features and advantages will be apparent from the following description as well as the accompanying drawings, to which reference is made. In the drawings:

FIG. 1 shows a schematic view of an embodiment of a system according to an embodiment of the disclosure with code reading units according to an embodiment of the disclosure,

FIG. 2 a code reading unit and a main device of the system of FIG. 1 in a more detailed schematic view, and

FIG. 3 a schematic flowchart of a method according to an embodiment of the disclosure.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

FIG. 1 shows a schematic view of a shop floor 10, e.g. a warehouse having a plurality of workstations, shelves or other places to carry our tasks, called location 12 in the following.

A system 14 is used on the shop floor 10 comprising a plurality of code reading units 16, a plurality of vehicles 18, each comprising a main device 20, and a system control unit 22.

The system control unit 22 controls the system 14 and is, for example, an application running on a server, like a cloud server or a server on premise.

The code reading units 16 are carried by users U, e.g. workers working on the shop floor 10, in particular in the vicinity of the locations 12.

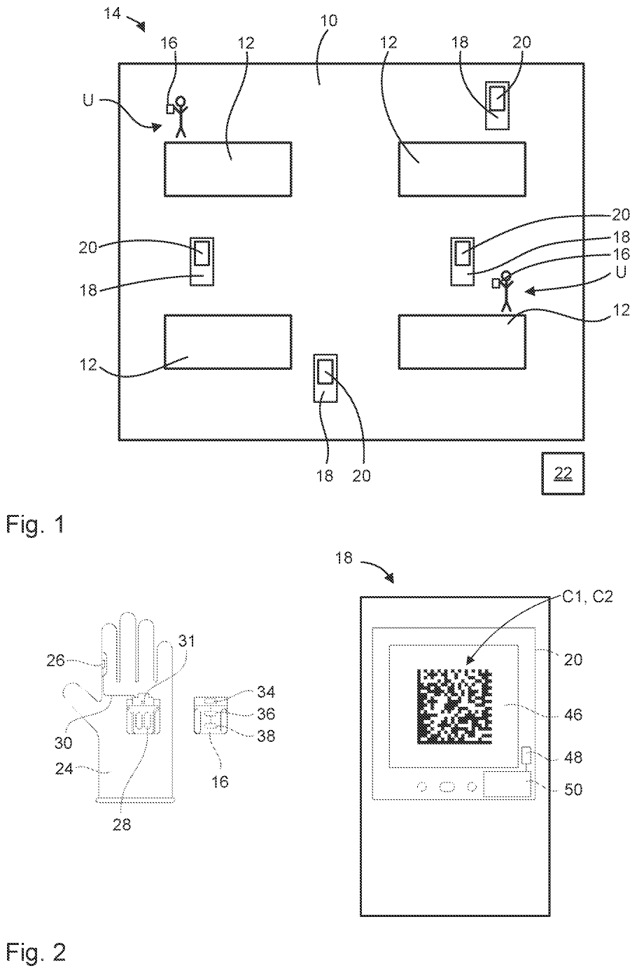

FIG. 2 shows an article of clothing 24, in this example a glove, one of the code reading units 16 and one of the vehicles 18 in a schematic view. The article of clothing 24 is worn by the user U.

The article of clothing 24 comprises an actuating element 26 and a holder 28.

The actuating element 26 may be a trigger button or a capacitive sensor and is located at the index finger of the user's hand when the glove is being worn.

The holder 28 is located at the back of the hand when the glove is being worn.

The holder 28 is designed to receive the code reading unit 16, wherein the actuating element 26 is connected to the code reading unit 16 in the holder 28 via a conductor 30, for example a cable or flex-PCB integrated into the article of clothing 24, and a contact point 31.

The glove, with a code reading unit 16 inserted into the holder 28, is worn by the user U so that the user U can easily activate the code reading unit 16 by actuating the actuating element 26 with the thumb.

The code reading unit 16 comprises a code reader 34, a control unit 36 and a wireless communication module 38.

The code reader 34, also called scan engine, is an optical code reader 34 configured to read machine-readable codes, like barcodes, two-dimensional codes, for example QR codes, data matrix codes or the like, or any other optical machine-readable code.

It is also conceivable that the code reader is another type of code reader, for example for reading RFID-tags.

The wireless communication module 38 may be configured to establish Bluetooth connections, in particular Bluetooth low energy connections and/or WLAN connections with other wireless communication modules.

The vehicles 18 are automated, in particular autonomous, and thus move in automated or autonomous fashion through the shop floor 10.

The main device 20 is mounted on the vehicle 18 and controls the movement of the vehicle 18.

The main device 20 comprises at least a display 46 and also a wireless communication module 48 and a control unit 50. The main device 20 is, for example, a smart device, in particular a smart phone, a tablet or a laptop.

The wireless communication module 48 is configured to establish a wireless connection to the wireless communication module 38 of the code reading unit 16. It may thus also be a Bluetooth, Bluetooth low energy enabled device and/or a WLAN device.

With the wireless communication module 48 or a second wireless communication module (not shown), the main device 20 of the vehicle 18 establishes a communication connection with the system control unit 22 in order to receive and transmit data.

The vehicle may be controlled by the control unit 50 of the main device 20 autonomously as per se known in the art. The vehicle 18 may thus be regarded as an autonomous drone or robot.

During use of the system 14, each of the vehicles 18, more precisely its main device 20, has been assigned a task on the shop floor 10. To this end, the main device 20 has received the task by the system control unit 22.

The vehicle 18 navigates autonomously to the location 12 at which the assigned tasked may be carried out.

At the respective location 12, one of the users U will use its code reading unit 16 to establish a wireless connection between the code reading unit 16 and the main device 20 in order to support the vehicle 18 in carrying out its task.

The user U will then perform steps of the task 18. While doing so, the user U reads codes located at the respective location 12 and/or items with the code reading unit 16.

Once the steps of the task are completed by the user U, the vehicle 18 moves away, either to another location 12 or to a base station (not shown). Then, the user U is free to support another vehicle 18 that is approaching his or her location 12. To this end, the user U has to connect its code reading unit 16 to the other vehicle 18.

Due to the design of the system 14, the code reading unit 16 of each user U has to connect to many different vehicles 18 during one shift. More precisely, the wireless communication modules 38 of the code reading units 16 have to connect to many wireless communication modules 48 of main devices 20 of different vehicles 18 in a seamless fashion.

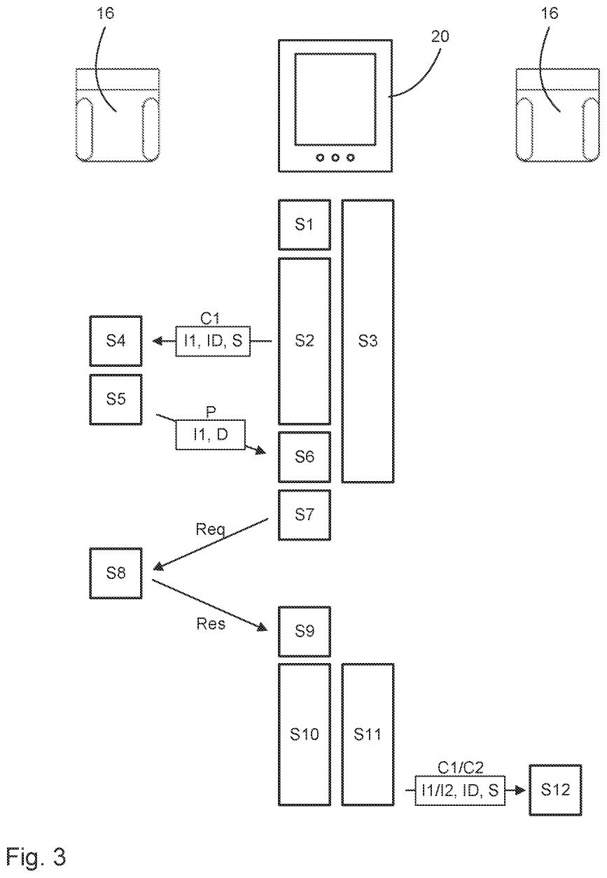

To this end, a method as depicted in FIG. 3 is carried out by the system 14, in particular the code reading unit 16.

In the beginning, neither the code reading unit 16 is connected to another vehicle 18 nor the vehicle 18 is connected to a code reading unit 16.

In a first step S1, the main device 20 of the vehicle 18 allows connections to code reading unit 16. To this end, the main device 20 generates a code having an identifier encoded therein. The code may be a barcode or a two-dimensional code, like a QR code or data matrix code.

The code is in particular designed such that it is readable by the code reader 34 of the code reading units 16.

For the ease of reference only, the code is called first code C1 and the identifier is called first identifier I1 in the following.

In addition to the first identifier I1, the first code C1 may have encoded therein a unique identifier ID of the main device 20. The unique identifier ID may be used later during the handshake process.

Then, in step S2, the main device 20 displays the first code C1 on the display 46, in particular in a way (i.e. adequate in a size and with a high contrast) to be easily read by the code reader 34 of a code reading unit 16.

After that, at the same time or even before step S1 and/or step S2, the main device 20 searches for code reading units 16 broadcasting the first identifier I1 (step S3). More precisely, the wireless communication module 48 of the main device 20 scans for other wireless communication modules, namely communication modules 38 of code reading units 16, that are broadcasting the first identifier I1.

The first identifier I1 is in particular an advertising name, for example used in Bluetooth communication.

In step S4, one code reading unit 16 (called first code reading unit 16 in the following for the ease of reference only) reads the first code C1 displayed by the main device 20.

To this end, the user U directs the code reader 34 of the first code reading unit 16 towards the display 46 of the main device 20 and actuates the actuating element 26.

The code reader 34 then captures a recording of its field of view, including the display 46 showing the first code C1.

The code reader 34 then, also in step S4, extracts the first identifier I1 from the first code C1.

Then, in step S5, the first identifier I1 is transmitted to the control unit 36 which, in turn, controls the wireless communication module 38 of the first code reading unit 16 to broadcast the first identifier I1.

Broadcasting may also be called “advertising”. Advertising may be done by sending an initial advertising packet P, which comprises, for example, the first identifier I1 and details D about the code reading unit 16.

The advertising packet P may also include the unique identifier ID of the main device 20.

As the main device 20 searches for code reading units 16 broadcasting the first identifier I1, the broadcasted first identifier I1 in the advertising packet P is then detected by the main device 20, more precisely its wireless communication module 48 (step S6).

The main device 20, more precisely its wireless communication module 48, then sends a connection request Req to the first code reading unit 16, more precisely its wireless communication module 38, in response to the reception of the first identifier I1 (step S7).

The connection request Req may also be called “scan request” and/or the first code reading unit 16 may be regarded as a “discovered device” by the main device 20.

Further, the code reading unit 16 may check, based on the unique identifier ID included in the first code C1, whether the connection request Req originated from the correct main device 20, i.e. the main device 20 that had displayed the first code C1.

In step S8, the first code reading unit 16 receives the connection request Req and transmits a connection response Res to the main device 20.

The connection response Res is based on the connection request Req and may also be called a “scan response”.

The connection response Res does not contain the first identifier I1.

To this end, for example, the first code C1 has encoded therein a setting S for the wireless communication module 38 to of the first code reading unit 16 not to include the first identifier I1 in the connection response Res. The code reading unit 16 had adopted the setting after having read and decoded the first code C1.

In step S9, the main device 20 receives the connection response Res and the wireless connection between the main device 20 and the code reading unit 16 is then established.

This type of handshake with the connection response Res not including the first identifier I1 may also be referred to as a “single handshake”. In contrast to the single handshake, the “double handshake” procedure to establish a connection between a main device and a peripheral device includes the first identifier as part of the connection response Res yet again.

In particular, the main device 20 refrains from caching the first code reading unit 16, e.g. the details D, with the first identifier I1. Thus, the first identifier I1 and the first code reading unit 16 remain independent from another from the point of view of the main device 20.

The established wireless connection may then be used to transfer data between the main device 20 and the first code reading unit 16. In particular, the first code reading unit 16 transmits information about the codes scanned by the code reader 34 to the main device 20, for example the decoded information contained in the code.

Via the established wireless connection, the user U may interact with the vehicle 18 also in other advantageous ways. For example, the user U and the vehicle 18, i.e. the main device 20, may speak to one another using a headset of the user U connected to the code reading unit 16. Thus, the vehicle 18 may give and/or receive voice commands concerning the tasks.

The user U may then scan barcodes associated with and provided at the location 12 or items at the location 12 to be handled by the user U. These codes are then transmitted to the main device 20 and/or forwarded to the system control unit 22 to track and supervise the steps of the task.

Once the user U has completed the step of the task at this particular location 12 for the vehicle 18, the vehicle 18 proceeds to another location 12 and the communication connection between the vehicle 18, more precisely the main device 20, and the first code reading unit 16 is terminated.

Termination of the communication connection may be active, for example once a user presses a button on the display 46 or any other input device of the main device 20 indicating that he or she has placed all goods into the vehicle 18.

The communication connection may also be terminated passively. For example, as the vehicle 18 moves away from the user U, the connection between the main device 20 and the first code reading unit 16 may be lost when the devices are out of range from one another.

The communication connection may also be terminated once another code reading unit 16, called second code reading unit 16 in the following only for the ease of differentiation, establishes a communication connection with the main device 20 of the vehicle 18.

Regardless of the way the communication connection has been terminated, the first code reading unit 16 that had been connected to the main device 20 does not attempt to reconnect to the main device 20 and vice versa. The first code reading unit 16, and in particular all other code reading units 16, are therefore configured to refrain from attempts to reconnect to the main device 20.

In order to configure the first code reading unit 16 to refrain from attempts to reconnect, the first code C1 may have encoded therein a setting S for the code reading unit 16, in particular for the wireless communication module 38 of the code reading unit 16, to refrain from attempts to reconnect. The code reading unit 16 then adopts the setting in step S4 after having read and decoded the respective code C1.

In much the same way, the main device 20, in particular the wireless communication module 48 of the main device 20, refrains from attempts to reconnect to the first code reading unit 16 once the wireless connection to the first code reading unit 16 has been terminated.

In order to allow a connection to the second code reading unit 16, i.e. any other code reading unit 16, the main device 20 remains in or enters a state of state of continuous availability, meaning that the main device 20 searches for a code reading unit 16 other than the first code reading unit 16 broadcasting the first identifier I1.

Optionally, the main device 20 continues or restarts to display the first code C1 on the display 46 (steps S10).

Alternatively or in addition, the main device 20 generates a second code C2 and displays the second code C2 on the display 46 (step S10).

Much like the first code C1, the second code C2 has encoded therein a second identifier I2 and optionally the unique identifier ID of the main device 20 and/or settings S.

Step S10 is thus fully or virtually identical to step S1, as the differentiation between first code C1 and the second code C2 is just for the ease of understanding. The first code C1 and the second code C2 thus only differ by the identifier I1, I2 as the first identifier I1 and second identifier I2 are different from one another.

Step S10 may be carried out as soon as the wireless connection between the first code reading unit 16 and the main device 20 has been established. It is also conceivable that step S10 is carried out just when the wireless connection between the first code reading unit 16 and the main device 20 has been terminated.

In particular, step S10 is carried out automatically and may also be carried out even if the wireless connection between the main device 20 and the first code reading unit 16 is still active. Automatically means, for example, that no user input is required to start step S10. This includes the case, in which the wireless connection is terminated due to a user input at the main device 20.

Simultaneously to step S10, if a second code C2 has been generated and is displayed, the main device 20 starts to search for code reading units 16 broadcasting the second identifier I2 (step S11).

Then, another user U wearing the second code reading unit 16 may read the code—being the first code C1 or the second code C2—of the display 46 of the main device 20 of the vehicle 18 (Step S12) in order to establish a connection between the worn (second) code reading unit 16 and the main device 20 (step S12).

If the wireless connection between the first code reading unit 16 and the main device 20 is still active, the main device 20 terminates this connection to the first code reading unit 16 once the main device 20 detects a second code reading unit 16 broadcasting the first identifier I1 or—if a second code C2 has been generated—the second identifier I2.

For establishing the wireless connection between the second code reading unit 16 and the main device 20, steps S2 to S9 are carried out in the same fashion. A wireless connection is thus established with this second code reading unit 16.

By carrying out this method, a very uncomplicated way of establishing and terminating wireless communication connections between the code reading unit 16 and the vehicles 18 is achieved, even though other devices, to which no wireless connection is intended at the moment, are within the range of the code reading unit 16 and the main device 20 almost at any time.

1. A method for operating a system comprising a plurality of code reading units with a code reader and a wireless communication module as well as a main device having a display and a wireless communication module, wherein the method comprises the following steps:
generating a first code readable by the code reading units, the first code having encoded a first identifier therein,
displaying the first code on the display by the main device and searching for a code reading unit broadcasting the first identifier by the main device using the wireless communication module,
reading the first code and decoding the first code by a first code reading unit of the plurality of code reading units obtaining the first identifier,
broadcasting the first identifier by the first code reading unit using the wireless communication module, and
establishing a wireless connection between the main device and the first code reading unit based on the first identifier,
wherein the wireless connection between the main device and the first code reading unit is established by the following steps:
detecting by, the main device using the wireless communication module, the first code reading unit broadcasting the first identifier,
sending, by the main device using the wireless communication module, a connection request to the first code reading unit, and
receiving, by the main device using the wireless communication module, a connection response as a response to the connection request from the first code reading unit,
wherein at least one of the following: the connection response does not contain the first identifier; or the main device refrains from caching the first code reading unit with the first identifier.

2. The method according to claim 1, wherein the code having encoded therein a setting for the wireless communication module of the code reading unit to not include the first identifier in the connection response, wherein the code reading unit adopts the setting after reading the respective code.

3. The method according to claim 1, wherein once the wireless connection between the first code reading unit and the main device has been established, one or more of the following steps are carried out by the main device:
searching for a code reading unit other than the first code reading unit broadcasting the first identifier using the wireless communication module;
displaying a code on the display, the code being the first code or a second code, the second code having encoded therein a second identifier;
searching for a code reading unit other than the first code reading unit broadcasting the second identifier using the wireless communication module.

4. The method according to claim 3, wherein the code is at least one of displayed automatically or displayed even if the wireless connection between the main device and the first code reading unit is still active.

5. The method according to claim 3, wherein once the main device detects a second code reading unit of the plurality of code reading units broadcasting the first identifier or the second identifier, respectively, the main device terminates the connection to the first code reading unit and establishes a connection with the second code reading unit.

6. The method according to claim 1, wherein the wireless communication module of at least one of the code reading units or of the main device is set to refrain from attempts to reconnect to the main device or to a previous connected code reading unit, respectively, once the established wireless connection between the first code reading unit and the main device has been terminated.

7. The method according to claim 6, wherein the code having encoded therein a setting for the wireless communication module of the code reading unit to refrain from attempts to reconnect to the main device, wherein the code reading unit adopts the setting after reading the respective code.

8. The method according to claim 3, wherein the first and second identifiers are at least one of advertising names or different from one another.

9. The method according to claim 1, wherein the wireless connection is a Bluetooth connection or a WLAN connection.

10. The method according to claim 1, wherein the codes having encoded therein a unique identifier of the main device.

11. The method according to claim 1, wherein the system comprises an automated vehicle, the vehicle comprising the main device.

12. The method according to claim 11, wherein the automated vehicle is an autonomous vehicle.

13. The method according to claim 1, wherein the main device is a smart device.

14. The method according to claim 13, wherein the main device is a smartphone, a tablet or a laptop.

15. The method according to claim 1, wherein the system comprises an article of clothing, which is designed to attach the code reading unit to a body of a user.

16. The method according to claim 15, wherein the article of clothing has an actuating element which is connected to the code reading unit such that it can actuate the code reading unit.

17. The method according to claim 15, wherein the article of clothing is a glove.

18. A system comprising a plurality of code reading units with a code reader and a wireless communication module, and a main device having a display and a wireless communication module, wherein the code reading unit and the main device are configured to carry out a method comprising the following steps:
generating a first code readable by the code reading units, the first code having encoded a first identifier therein,
displaying the first code on the display by the main device and searching for a code reading unit broadcasting the first identifier by the main device using the wireless communication module,
reading the first code and decoding the first code by a first code reading unit of the plurality of code reading units obtaining the first identifier,
broadcasting the first identifier by the first code reading unit using the wireless communication module, and
establishing a wireless connection between the main device and the first code reading unit based on the first identifier,
wherein the wireless connection between the main device and the first code reading unit is established by the following steps:
detecting by, the main device using the wireless communication module, the first code reading unit broadcasting the first identifier,
sending, by the main device using the wireless communication module, a connection request to the first code reading unit, and
receiving, by the main device using the wireless communication module, a connection response as a response to the connection request from the first code reading unit,
wherein at least one of the following: the connection response does not contain the first identifier; or the main device refrains from caching the first code reading unit with the first identifier.

19. A code reading unit with a code reader and a wireless communication module, wherein the code reading unit is configured to:
read a first code displayed by a main device and decode the first code obtaining a first identifier,
broadcast the first identifier using the wireless communication module,
establish a wireless connection with the main device based on the first identifier by sending a connection response in reaction to a connection request from the main device, wherein the connection response does not contain the first identifier.

20. The code reading unit according to claim 19, wherein the code reading unit is configured to refrain from attempts to reconnect to the main device.
